(19) United States
(12) Patent Application Publication
(10) Pub. No.: US 2026/0331056 A1
(43) Pub. Date: Oct. 22, 2026

(54) DISPLAY DRIVER, DISPLAY MODULE, AND ELECTRONIC DEVICE

(71) Applicant: HUAWEI TECHNOLOGIES CO., LTD., Shenzhen (CN)

(72) Inventors: Yang Lu, Chengdu (CN); Chengyu Yu, Shenzhen (CN); Xiaopeng Chen, Shenzhen (CN); Congbiao Jiang, Shenzhen (CN); Kang Wu, Shenzhen (CN); Shengchao Wang, Shenzhen (CN)

(73) Assignee: HUAWEI TECHNOLOGIES CO., LTD., Shenzhen (CN)

(21) Appl. No.: 19/710,979

(22) Filed: Jun. 17, 2026

Related U.S. Application Data
(63) Continuation of application No. PCT/CN2024/139715, filed on Dec. 16, 2024.

(30) Foreign Application Priority Data
Dec. 22, 2023 (CN) 202311788343.4

(51) Int. Cl. G09G 3/3233; G09G 3/20; G09G 3/3275

(52) U.S. Cl. CPC G09G 3/3233; G09G 3/2007; G09G 3/2096; G09G 3/3275; G09G 2300/0819; G09G 2300/0842; G09G 2300/0861; G09G 2320/0247; G09G 2320/041; G09G 2330/028; G09G 2340/0435; G09G 2370/08

(57) ABSTRACT

An example display driver includes a timing controller and a source driver. The timing controller includes a voltage calculation circuit, an identifier generation circuit, and a P2P transmission circuit. The voltage calculation circuit is configured to determine a voltage value of an initialization signal needed during displaying of an i^{th} row of pixel circuit of a display. The identifier generation circuit is configured to generate a switching identifier, where the switching identifier indicates the display to switch to the i^{th} row of pixel circuit for displaying. The P2P transmission circuit is configured to send the switching identifier and the voltage value of the initialization signal to the source driver through a P2P setting instruction. The source driver is configured to provide the initialization signal for the display based on the switching identifier and the voltage value during displaying of the i^{th} row of pixel circuit of the display.

### CROSS-REFERENCE TO RELATED APPLICATIONS

This application is a continuation of International Application No. PCT/CN2024/139715, filed on Dec. 16, 2024, which claims priority to Chinese Patent Application No. 202311788343.4, filed on Dec. 22, 2023. The disclosures of the aforementioned applications are hereby incorporated by reference in their entireties.

### TECHNICAL FIELD

This application relates to the field of electronic technologies, and in particular, to a display driver, a display module, and an electronic device.

### BACKGROUND

In a display driver of a medium/large-sized display, a timing controller (TCON), a source driver (Source IC), and the like are separated, and are not implemented in a same chip. This architecture is referred to as a TCON-source split architecture. The timing controller and the source driver may transmit data and commands based on a point-to-point (P2P) protocol.

During displaying of the display, the display driver needs to provide an initialization signal to initialize a pixel circuit. In the TCON-source split architecture, it is difficult to flexibly and dynamically adjust the initialization signal, and there is a great challenge to timeliness.

### SUMMARY

Embodiments of this application provide a display driver, a display module, and an electronic device, to simplify initialization signal adjustment in a TCON-source split architecture.

According to a first aspect, a display driver is provided. The display driver circuit includes a timing controller and a source driver. The timing controller includes a voltage calculation circuit, an identifier generation circuit, and a point-to-point P2P transmission circuit. The voltage calculation circuit is configured to determine a voltage value of an initialization signal needed during displaying of an i^{th} row of pixel circuit of a display, where i is a positive integer. The identifier generation circuit is configured to generate a switching identifier when the display switches to the i^{th} row of pixel circuit for displaying, where the switching identifier indicates a switching occasion of the initialization signal. The P2P transmission circuit is configured to send the switching identifier and the voltage value of the initialization signal to the source driver through a P2P setting instruction. The source driver is configured to provide the initialization signal for the display based on the switching identifier and the voltage value during displaying of the i^{th} row of pixel circuit of the display.

According to the display driver provided in this embodiment of this application, the voltage calculation circuit and the identifier generation circuit are configured in the TCON. The voltage calculation circuit determines the voltage value of the initialization signal needed during displaying of the i^{th} row of pixel circuit of the display. The identifier generation circuit may generate the switching identifier. The P2P transmission circuit sends the voltage value of the initialization signal and the switching identifier to the source driver through the P2P setting instruction. A voltage generator is configured in the source driver. The voltage generator may provide the initialization signal for the display based on the voltage value and the switching identifier during displaying of the i^{th} row of pixel circuit of the display, to initialize the pixel circuit, and avoid a black screen, erratic display, display flicker, and the like. Compared with a solution in which an initialization signal is adjusted through software configuration, the solution provided in this embodiment of this application is completed by logic hardware. A voltage value of an initialization signal needed during displaying of each row of pixel circuit may be calculated, the voltage value and a switching identifier may be sent to the source driver through a P2P setting instruction, a voltage of the initialization signal may be adjusted in a row-wise manner based on the switching identifier, to ensure timely adjustment.

In a possible implementation, the voltage calculation circuit is specifically configured to determine, based on a display condition, screen temperature, a frame rate, and a first lookup table, the voltage value of the initialization signal needed by the display, where the first lookup table stores a correspondence between the display condition, the screen temperature, the frame rate, and the voltage value of the initialization signal needed by the display, and the display condition includes any one of a grayscale histogram, a maximum grayscale pixel, an average grayscale, and screen brightness. The voltage calculation circuit may dynamically adjust the voltage value of the initialization signal based on the display condition, the screen temperature, and the frame rate, so that an adjustment manner is more flexible.

In a possible implementation, the voltage calculation circuit includes a basic voltage calculation unit, a temperature compensation calculation unit, a frame rate compensation calculation unit, and an addition circuit. The basic voltage calculation unit is configured to determine a voltage value of a basic voltage based on a display condition and a second lookup table, where the second lookup table stores a correspondence between the display condition and the voltage value of the basic voltage, and the display condition includes any one of a grayscale histogram, a maximum grayscale pixel, an average grayscale, and screen brightness. The temperature compensation calculation unit is configured to determine a voltage value of a temperature compensation voltage based on screen temperature and a third lookup table, where the third lookup table stores a correspondence between the temperature and the voltage value of the temperature compensation voltage. The frame rate compensation calculation unit is configured to determine a frame rate compensation voltage based on a frame rate and a fourth lookup table, where the fourth lookup table stores a correspondence between the frame rate and a voltage value of the frame rate compensation voltage. The addition circuit is configured to sum up the voltage value of the basic voltage, the voltage value of the temperature compensation voltage, and the voltage value of the frame rate compensation, and output the voltage value of the initialization signal needed by the display.

In a possible implementation, the source driver includes a voltage generator, and the voltage generator is configured to output, based on the voltage value sent by the P2P transmission circuit, the initialization signal during displaying of the i^{th} row of pixel circuit of the display.

In a possible implementation, the timing controller includes a first voltage calculation circuit and a second voltage calculation circuit. The first voltage calculation circuit is configured to determine a voltage value of a positive-voltage initialization signal needed during displaying of the i^{th} row of pixel circuit of the display. The second voltage calculation circuit is configured to determine a voltage value of a negative-voltage initialization signal needed during displaying of the i^{th} row of pixel circuit of the display. The source driver includes a first selection unit, a first voltage generator, and a second voltage generator. The first voltage generator is configured to output the positive-voltage initialization signal based on the voltage value of the positive-voltage initialization signal. The second voltage generator is configured to output the negative-voltage initialization signal based on the voltage value of the negative-voltage initialization signal. The first selection unit is configured to choose, based on a selection signal, to output the positive-voltage or negative-voltage initialization signal during displaying of the i^{th} row of pixel circuit of the display. For an initialization signal for implementing positive and negative voltage adjustment, two voltage generators may be disposed, where one voltage generator is configured to generate a positive-voltage initialization signal, and the other voltage generator is configured to generate a negative-voltage initialization signal. A selection unit chooses, based on a selection signal like a switching identifier, to switch to the positive-voltage or negative-voltage initialization signal. In comparison with a solution in which a single voltage generator switches between positive voltage adjustment and negative voltage adjustment, timeliness of switching between a positive voltage and a negative voltage can be improved.

In a possible implementation, the source driver includes a second selection unit and a voltage generator. The second selection unit is configured to choose, based on a selection signal, to output, to the voltage generator, a first voltage value sent by the P2P transmission circuit through a P2P line setting instruction or a second voltage value sent by the P2P transmission circuit through a P2P frame setting instruction. The voltage generator is configured to output the initialization signal based on the first voltage value or the second voltage value that is output by the second selection unit.

In a possible implementation, the selection signal is a switching identifier sent by the P2P transmission circuit through a P2P line setting instruction.

In a possible implementation, the P2P transmission circuit includes a register and a third selection unit. The register stores a voltage value of an initialization signal that is configured by software. The P2P transmission circuit is further configured to send, to the source driver through the third selection unit, the voltage value in the register or the voltage value output by the voltage calculation circuit.

In a possible implementation, the P2P transmission circuit includes a register and a fourth selection unit. The register stores a selection signal configured by software. The P2P transmission circuit is further configured to choose, through the fourth selection unit, to use the switching identifier as a selection signal or send the selection signal in the register to the source driver through a P2P line setting instruction.

According to a second aspect, a display module is provided. The display module includes a display and the display driver provided in any one of the implementations of the first aspect. The display driver is configured to output an initialization signal to the display.

According to a third aspect, an electronic device is provided. The electronic device includes a housing and the display module provided in the second aspect. The display module is installed on the housing.

### BRIEF DESCRIPTION OF DRAWINGS

FIG. 1 is a diagram of an electronic device according to an embodiment of this application;

FIG. 2 is a diagram of a display module according to an embodiment of this application;

FIG. 3 is a diagram of a pixel circuit according to an embodiment of this application;

FIG. 4 is a diagram of an architecture of a display module according to an embodiment of this application;

FIG. 5 is a diagram of a display driver;

FIG. 6 is a diagram of a display driver according to an embodiment of this application;

FIG. 7 is a diagram of a voltage calculation circuit according to an embodiment of this application;

FIG. 8 is a diagram of another voltage calculation circuit according to an embodiment of this application;

FIG. 9 is a diagram of another display driver according to an embodiment of this application;

FIG. 10 is a diagram of another display driver according to an embodiment of this application;

FIG. 11 is a diagram of another display driver according to an embodiment of this application;

FIG. 12 is a diagram of another display driver according to an embodiment of this application;

FIG. 13 is a diagram of another display driver according to an embodiment of this application; and

FIG. 14 is a diagram of another display driver according to an embodiment of this application.

### DESCRIPTION OF EMBODIMENTS

The following describes the technical solutions in embodiments of this application with reference to the accompanying drawings in embodiments of this application. Clearly, the described embodiments are merely some but not all of embodiments of this application.

The terms “first”, “second”, and the like below are merely intended for ease of description, and shall not be construed as indicating or implying relative importance or implicitly indicating a quantity of indicated technical features. Therefore, a feature defined by “first”, “second”, or the like may explicitly or implicitly include one or more features. In the descriptions of this application, “a plurality of” means two or more, unless otherwise specified.

In embodiments of this application, orientation terms such as “above”, “below”, “left”, and “right” may include but are not limited to being defined relative to placement orientations of components shown in the accompanying drawings. It should be understood that these directional terms may be relative concepts used for relative description and clarification, and may vary correspondingly based on changes in the placement orientations of the components in the accompanying drawings.

In embodiments of this application, unless otherwise clearly specified and limited, the term “connection” should be understood in a broad sense. For example, the “connection” may be fastening, a detachable connection, or an integrated connection, or may be a direct connection or an indirect connection implemented through an intermediate medium. In addition, the term “electrical connection” may be a direct electrical connection or an indirect electrical connection through an intermediate medium. The term “contact” may be direct contact or indirect contact through an intermediate medium.

In embodiments of this application, “and/or” describes an association relationship between associated objects, and indicates that three relationships may exist. For example, A and/or B may indicate the following cases: Only A exists, both A and B exist, and only B exists, where A and B may be in a singular form or a plural form. The character “/” usually indicates an “or” relationship between the associated objects.

In embodiments of this application, a transistor may be a metal-oxide-semiconductor field effect transistor (MOSFET), and transistors are classified into two types: an N-type transistor and a P-type transistor.

The transistor includes a source, a drain, and a gate. By controlling a level input to the gate of the transistor, the transistor may be controlled to be turned on or cut off. When the transistor is turned on, the source and the drain conduct, and a conduction current is generated. In addition, a magnitude of the conduction current generated between the source and the drain varies with the level at the gate of the transistor. When the transistor is cut off, the source and the drain do not conduct, and no current is generated. In embodiments of this application, the gate of the transistor is also referred to as a control end, the source is referred to as a first end, and the drain is referred to as a second end; or the gate is referred to as a control end, the drain is referred to as a first end, and the source is referred to as a second end. In addition, when a level at the control end is a high level, the N-type transistor is turned on, the first end and the second end conduct, and a conduction current is generated between the first end and the second end; or when a level at the control end is a low level, the N-type transistor is cut off, the first end and the second end do not conduct, and no current is generated. When a level at the control end is a low level, the P-type transistor is turned on, the first end and the second end conduct, and a conduction current is generated; or when a level at the control end is a high level, the P-type transistor is cut off, the first end and the second end do not conduct, and no current is generated.

An embodiment of this application provides an electronic device. The electronic device is, for example, a consumer electronic product, a home electronic product, a vehicle-mounted electronic product, or a financial electronic device product that has a display function. The consumer electronic product is, for example, a mobile phone, a tablet computer (pad), a notebook computer, an e-reader, a personal computer (PC), a personal digital assistant (PDA), a desktop display, an intelligent wearable product (for example, a smartwatch or a smart band), a virtual reality (VR) electronic device, an augmented reality (AR) electronic device, or an uncrewed aerial vehicle. The home electronic product is, for example, a smart door lock, a television, a remote control, a refrigerator, or a small charging home appliance (for example, a soy milk maker or a robot vacuum). The vehicle-mounted electronic product is, for example, a vehicle-mounted navigator or a vehicle-mounted high-density digital video disc (DVD). The financial electronic device product is, for example, an automated teller machine (ATM) or an electronic device for self-help services. A specific form of the electronic device is not particularly limited in embodiments of this application.

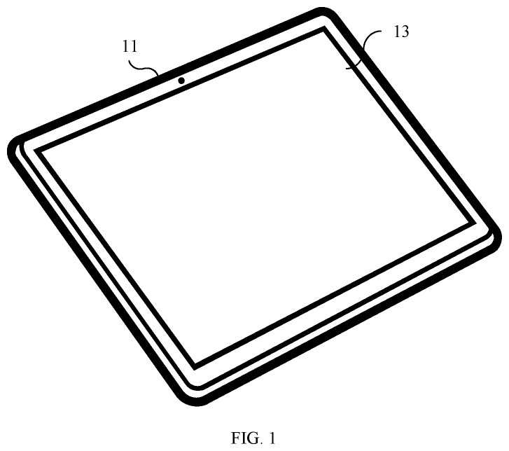

For ease of description, an example in which the electronic device is a tablet computer is used below for description. As shown in FIG. 1, the electronic device includes a housing 11 and a display module 13.

In a possible implementation, a main board may be installed on the housing 11, the main board may include a printed circuit board (PCB) or a flexible circuit board (FPC), and the display module 13 may be installed on the housing 11 and coupled to the PCB or the FPC.

The display module 11 may include a display driver and at least one display. In some embodiments, the display may be a display that can implement self-illumination, for example, an organic light-emitting diode (OLED) display, a micro organic light-emitting diode (micro OLED) display, or a quantum dot light-emitting diode (QLED) display.

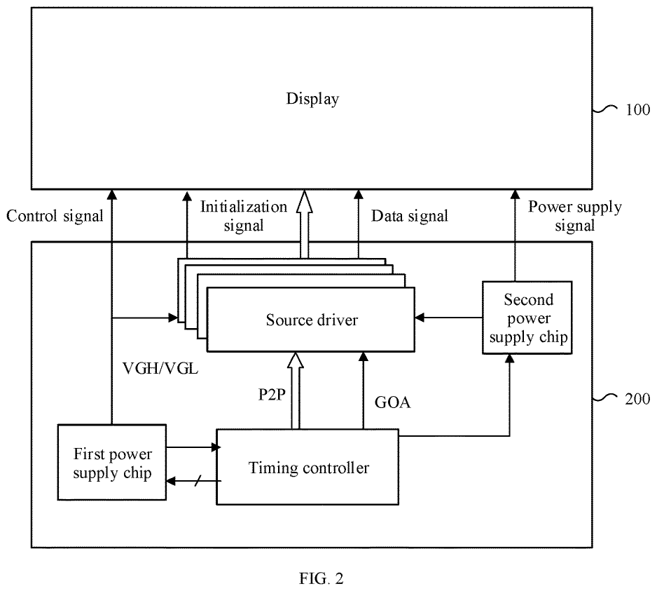

FIG. 2 is a diagram of a display module. The display module includes a display 100 and a display driver 200. The display driver 200 is configured to provide, for a pixel circuit in the display 100, a power supply signal, a control signal, an initialization signal, a data signal, and the like that are needed for light emitting. With reference to a structure of the pixel circuit, the following describes in detail a signal sent by the display driver 200. The display driver 200 is, for example, a display driver integrated circuit (DDIC).

The display driver 200 includes a timing controller (TCON), a source driver (Source IC), a first power supply chip, and a second power supply chip. The timing controller may serve as a control chip of the display driver 200, and may control running of the source driver, the first power supply chip, the second power supply chip, and the like.

The first power supply chip may be a chip power management integrated circuit (PMIC), and the second power supply chip may be an EL PMIC. The EL PMIC is configured to provide a power supply signal, for example, a positive power supply (ELVDD) and a negative power supply (ELVSS), for the display. The chip PMIC is configured to provide power supply signals for the display and the source driver. For example, the chip PMIC may provide a gate on voltage (VGH) and a gate off voltage (VGL) for the source driver. The source driver may generate an integrated gate circuit (GOA) signal and an initialization signal based on the two voltages. The GOA signal is a signal for controlling a row-level pixel circuit of the display to be turned on. The initialization signal is used to initialize the pixel circuit.

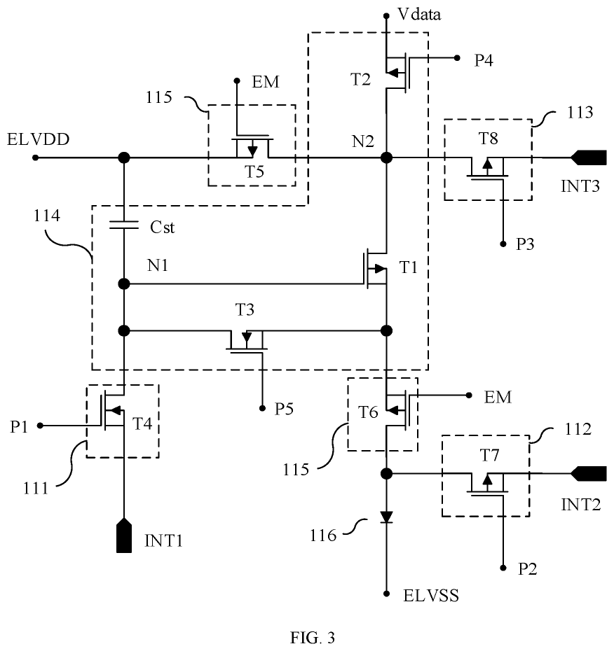

FIG. 3 is a diagram of a pixel circuit according to an embodiment of this application. A pixel circuit of an active organic light-emitting diode (AMOLED) display in a self-luminous display technology is used as an example. The pixel circuit includes a first initialization circuit 111, a second initialization circuit 112, a third initialization circuit 113, a writing and threshold compensation circuit 114, a light-emitting control circuit 115, and a light-emitting device 116. The pixel circuit 11 shown in FIG. 3 is merely an example, and constitutes no limitation.

The first initialization circuit 111 is electrically connected to a first initialization signal end INT1, a first control signal end P1, and a first node N1, and is configured to transmit a first initialization signal (Vint1) at the first initialization signal end INT1 to the first node N1 under the control of a first control signal at the first control signal end P1, to reset (or understood as initializing) the first node N1.

The second initialization circuit 112 is electrically connected to a second initialization signal end INT2, a second control signal end P2, and an anode of the light-emitting device 116, and is configured to transmit a second initialization signal (Vint2) at the second initialization signal end INT2 to the anode of the light-emitting device 116 under the control of a second control signal at the second control signal end P2, to reset (or understood as initializing) the anode of the light-emitting device 116.

The third initialization circuit 113 is electrically connected to a third initialization signal end INT3, a third control signal end P3, and a second node N2, and is configured to transmit a third initialization signal (Vint3) at the third initialization signal end INT3 to the second node N2 under the control of a third control signal at the third control signal end P3, to reset (or understood as initializing) the second node N2.

The writing and threshold compensation circuit 114 is electrically connected to a fourth control signal end P4, a fifth control signal end P5, the second node N2, a first power voltage end ELVDD, and a data voltage end Vdata, and is configured to transmit a data voltage at the data voltage end Vdata to the writing and threshold compensation circuit 114 under the control of a fourth control signal at the fourth control signal end P4 and a fifth control signal at the fifth control signal end P5, to perform data writing and threshold compensation.

The light-emitting control circuit 115 is electrically connected to a light-emitting control signal end (EM), the first power voltage end ELVDD, the writing and threshold compensation circuit 114, and the light-emitting device 116, and is configured to provide a driving current for the light-emitting device 116 under the control of a light-emitting control signal provided by the light-emitting control signal end EM.

The light-emitting device 116 is electrically connected to a second power voltage end ELVSS, and is configured to emit light under driving by the driving current.

In this embodiment of this application, an example in which the first power voltage end ELVDD is a high-level power voltage end and the second power voltage end ELVSS is a low-level power voltage end is used for description. However, this constitutes no limitation.

In some embodiments, still as shown in FIG. 3, the writing and threshold compensation circuit 114 includes a driving transistor (DTFT) T1. A control electrode (for example, a gate) of the driving transistor T1 is electrically connected to the first node N1 (namely, the first initialization circuit 111), and a first electrode (for example, a source or a drain) of the driving transistor T1 is electrically connected to the second node N2 (namely, the second initialization circuit 112).

Further, the writing and threshold compensation circuit 114 further includes a second transistor T2, a third transistor T3, and a storage capacitor Cst. The first initialization circuit 111 includes a fourth transistor T4. The second initialization circuit 112 includes a seventh transistor T7. The third initialization circuit 113 includes an eighth transistor T8. The light-emitting control circuit 115 includes a fifth transistor T5 and a sixth transistor T6.

The second transistor T2, the third transistor T3, the fourth transistor T4, the fifth transistor T5, the sixth transistor T6, the seventh transistor T7, and the eighth transistor T8 are switch transistors. The light-emitting device 116 is, for example, an OLED, a micro OLED, or a QLED.

In the following descriptions, a control electrode of a transistor may be, for example, a gate of the transistor, and a first electrode of the transistor and a second electrode of the transistor are respectively a source and a drain of the transistor. This is described herein, and is no longer described below.

The control electrode of the driving transistor T1 is electrically connected to the first node N1, the first electrode of the driving transistor T1 is electrically connected to the second node N2, and a second electrode of the driving transistor T1 is electrically connected to a first electrode of the third transistor T3.

A control electrode of the second transistor T2 is electrically connected to the fourth control signal end P4, a first electrode of the second transistor T2 is electrically connected to the data voltage end Vdata, and a second electrode of the second transistor T2 is electrically connected to the second node N2.

A control electrode of the third transistor T3 is electrically connected to the fifth control signal end P5, and a second electrode of the third transistor T3 is electrically connected to the first node N1.

One end of the storage capacitor Cst is electrically connected to the first node N1, and the other end of the storage capacitor Cst is coupled to the first power voltage end ELVDD.

A control electrode of the fourth transistor T4 is electrically connected to the first control signal end P1, a first electrode of the fourth transistor T4 is electrically connected to the first initialization signal end INT1, and a second electrode of the fourth transistor T4 is electrically connected to the first node N1.

A control electrode of the seventh transistor T7 is electrically connected to the second control signal end P2, a first electrode of the seventh transistor T7 is electrically connected to the second initialization signal end INT2, and a second electrode of the seventh transistor T7 is electrically connected to the anode of the light-emitting device 116.

A control electrode of the eighth transistor T8 is electrically connected to the third control signal end P3, a first electrode of the eighth transistor T8 is electrically connected to the third initialization signal end INT3, and a second electrode of the eighth transistor T8 is electrically connected to the second node N2.

A control electrode of the fifth transistor T5 is electrically connected to the light-emitting control signal end EM, a first electrode of the fifth transistor T5 is electrically connected to the first power voltage end ELVDD, and a second electrode of the fifth transistor T5 is electrically connected to the second node N2.

A control electrode of the sixth transistor T6 is electrically connected to the light-emitting control signal end EM, a first electrode of the sixth transistor T6 is electrically connected to the second electrode of the driving transistor T1, and a second electrode of the sixth transistor T6 is electrically connected to the anode of the light-emitting device 116.

For example, in the pixel circuit 11, the third transistor T3 and the fourth transistor T4 are oxide thin film transistors (Oxide TFT), are N-type transistors, and are turned on under the control of a high-level signal. Alternatively, the third transistor T3 and the fourth transistor T4 may be transistors of other types. This is not limited in this embodiment of this application. The driving transistor T1, the second transistor T2, the fifth transistor T5, the sixth transistor T6, the seventh transistor T7, and the eighth transistor T8 may be low-temperature polysilicon thin film transistors (LTPS TFT), are P-type transistors, and are turned on under the control of a low-level signal. Alternatively, the driving transistor T1, the second transistor T2, the fifth transistor T5, the sixth transistor T6, the seventh transistor T7, and the eighth transistor T8 may be transistors of other types. This is not limited in this embodiment of this application.

A light-emitting process of the pixel circuit 11 in an image frame may be divided into an initialization stage t1, a data writing and compensation stage t2, a light-emitting stage t3, and an anode reset stage t.

Initialization stage t1:

The first control signal at the first control signal end P1 changes from a low level to a high level, and then changes from the high level to the low level. Therefore, the fourth transistor T4 changes from being turned off to being turned on, and then changes from being turned on to being turned off. The second control signal at the third control signal end P3 changes from a high level to a low level, and then changes from the low level to the high level. Therefore, the eighth transistor T8 changes from being turned off to being turned on, and then changes from being turned on to being turned off.

The fifth control signal at the fifth control signal end P5 remains at a low level, and both the fourth control signal at the fourth control signal end P4 and the light-emitting control signal at the light-emitting control signal end EM remain at a high level. Therefore, all of the seventh transistor T7, the second transistor T2, the third transistor T3, the fifth transistor T5, and the sixth transistor T6 remain in an off state.

In the initialization stage t1, the fourth transistor T4 is turned on, to control voltage at the first node N1. Because the fourth transistor T4 is electrically connected to the control electrode of the driving transistor T1, in the initialization stage t1, voltage control at the control electrode of the driving transistor T1 and voltage control at one end of the storage capacitor Cst are implemented. In this way, a voltage at the control electrode of the driving transistor T1 and a voltage at the one end of the storage capacitor Cst are voltages of the first initialization signal (Vint1) at the first initialization signal end INT1. In other words, the voltage at the control electrode of the driving transistor T1 and the voltage at the one end of the storage capacitor Cst are reset.

In addition, the eighth transistor T8 is turned on, to control voltage at the second node N2. Because the eighth transistor T8 is electrically connected to the first electrode of the driving transistor T1, in the initialization stage t1, voltage control at the first electrode of the driving transistor T1 is implemented. In this way, a voltage at the first electrode of the driving transistor T1 is a voltage of the third initialization signal (Vint3) at the third initialization signal end INT3. In other words, the voltage at the first electrode of the driving transistor T1 is reset, to adjust a threshold voltage of the driving transistor T1.

Data writing and compensation stage t2:

The fourth control signal at the fourth control signal end P4 changes from a high level to a low level, and then changes from the low level to the high level. Therefore, the second transistor T2 changes from being turned off to being turned on, and then changes from being turned on to being turned off. The fifth control signal at the fifth control signal end P5 changes from a low level to a high level, and then changes from the high level to the low level. Therefore, the third transistor T3 changes from being turned off to being turned on, and then changes from being turned on to being turned off.

All of the second control signal at the second control signal end P2, the third control signal at the third control signal end P3, and the light-emitting control signal at the light-emitting control signal end EM remain at a high level, and the first control signal at the first control signal end P1 remains at a low level. Therefore, all of the seventh transistor T7, the eighth transistor T8, the fifth transistor T5, the sixth transistor T6, and the fourth transistor T4 remain in an off state.

In the data writing and compensation stage t2, the second transistor T2, the third transistor T3, and the driving transistor T1 are separately turned on, so that the data voltage at the data voltage end Vdata is stored in the storage capacitor Cst, to complete writing of the data voltage. In addition, compensation for the threshold voltage of the driving transistor T1 is implemented. A process of compensating for the threshold voltage of the driving transistor T1 may be considered as a process in which the driving transistor T1 changes from an on state to an off state.

Light-emitting stage t3:

The light-emitting control signal changes from a high level to a low level, and then changes from the low level to the high level. Therefore, the sixth transistor T6 and the fifth transistor T5 change from being turned off to being turned on, and then change from being turned on to being turned off.

The first control signal at the first control signal end P1 and the fifth control signal at the fifth control signal end P5 consistently remain at a low level, and both the fourth transistor T4 and the third transistor T3 remain in an off state. The second control signal at the second control signal end P2, the third control signal at the third control signal end P3, and the fourth control signal at the fourth control signal end P4 each consistently remain at a high level, and all of the seventh transistor T7, the eighth transistor T8, and the second transistor T2 remain in an off state.

In the light-emitting stage t3, the fifth transistor T5, the driving transistor T1, and the sixth transistor T6 are separately turned on, to transmit the driving current to the light-emitting device 116, and the light-emitting device 116 emits light under driving by the driving current.

Anode reset stage t:

The second control signal at the second control signal end P2 changes from a high level to a low level, and then changes from the low level to the high level. Therefore, the seventh transistor T7 changes from being turned off to being turned on, and then changes from being turned on to being turned off.

The first control signal at the first control signal end P1 and the fifth control signal at the fifth control signal end P5 remain at a low level. The third control signal at the third control signal end P3, the fourth control signal at the fourth control signal end P4, and the light-emitting control signal at the light-emitting control signal end EM remain at a high level. All of the third transistor T3, the fourth transistor T4, the second transistor T2, the fifth transistor T5, the sixth transistor T6, and the eighth transistor T8 remain in an off state.

In the anode reset stage t, the seventh transistor T7 is turned on, to control anode voltage of the light-emitting device 116, so that a voltage at the anode of the light-emitting device 116 is a voltage of the second initialization signal (Vint2) at the second initialization signal end INT2. In this way, the voltage at the anode of the light-emitting device 116 is reset.

In one image frame, the anode reset stage t may be performed once before each of the initialization stage t1, the data writing and compensation stage t2, and the light-emitting stage t3; or anode reset may be performed once before one or two of the initialization stage t1, the data writing and compensation stage t2, and the light-emitting stage t3.

A plurality of rows of pixel circuits 11 operate in a row-wise refresh manner. To be specific, after a first row of pixel circuit 11 completes the initialization stage t1, the data writing and compensation stage t2, the light-emitting stage t3, the anode reset stage t, and the like, a second row of pixel circuit 11 enters the initialization stage t1, the data writing and compensation stage t2, the light-emitting stage t3, the anode reset stage t, and the like, and then each subsequent row of pixel circuit 11 repeats the initialization stage t1, the data writing and compensation stage t2, the light-emitting stage t3, the anode reset stage t, and the like. By analogy, refresh is performed in a row-wise manner from top to bottom.

In the foregoing example, the first initialization signal (Vint1) is used to initialize the control electrode of the driving transistor T1 and the storage capacitor Cst in the initialization stage t1 of displaying. As shown in FIG. 3, during displaying, a data signal (Vdata) is written to the first node N1 through the second transistor T2, the driving transistor T1, and the transistor T3, to store charges in the storage capacitor Cst. If a voltage (at the first node N1) written to the storage capacitor Cst in a previous frame is 3 V and a voltage of a data signal in a current frame is 0 V, the 3 V needs to be erased when data of the current frame is written; otherwise, the data cannot be written. The first initialization signal (Vint1) may be used to initialize the control electrode of the driving transistor T1 and the storage capacitor Cst. For example, a −3 V first initialization signal may be used herein to initialize the voltage at the first node N1 to −3 V. In this way, assuming that the voltage (data voltage) of the data signal of the current frame ranges from 0 V to 5 V, any positive voltage can pull the voltage at the first node N1 from −3 V to the data voltage, to implement data writing. The first initialization signal needs to implement dynamic negative and positive voltage adjustment.

The second initialization signal (Vint2) is used to initialize the voltage at the anode of the light-emitting device 116, and is also used to eliminate impact of the previous frame. For example, during displaying of the previous frame, a grayscale displayed by the light-emitting device 116 is high, and the voltage of the anode is high. If a low grayscale needs to be displayed in the current frame, because the light-emitting device 116 has a parasitic capacitor, the high voltage of the previous frame has a residual in the parasitic capacitor, affecting displaying of the light-emitting device. For example, the previous frame is at a grayscale 255, and the current frame is at a grayscale 1. In this case, a residual voltage, in the parasitic capacitor, of the grayscale 255 of the previous frame discharges to the light-emitting device, increasing a display grayscale of the light-emitting device and making display brightness higher. Therefore, the voltage at the anode of the light-emitting device needs to be initialized by using the second initialization signal. For example, the voltage of the second initialization signal may be −3 V, to prevent the previous frame from affecting displaying of the current frame. In this embodiment of this application, the second initialization signal is used to initialize a residual voltage of the light-emitting device, and the voltage of the second initialization signal needs to implement negative voltage adjustment.

The third initialization signal (Vint3) is used to initialize the first electrode of the driving transistor T1, to adjust the threshold voltage of the driving transistor T1. The threshold voltage of the driving transistor T1 may drift. The drift of the threshold voltage of the driving transistor T1 affects display brightness, and causes flicker at a low frame rate and the like. Therefore, the drift of the threshold voltage of the driving transistor T1 needs to be rectified by using the third initialization signal in a period in which the light-emitting device does not perform displaying. For example, a high positive voltage (for example, 5 V) is applied to the first electrode of the driving transistor T1 at a specified frequency, to reset the threshold voltage of the driving transistor T1, and avoid flicker caused by the drift of the threshold voltage.

A low-temperature polycrystalline silicon oxide (LTPO)-based display has a small leakage current, and therefore can adapt to dynamic frame rate switching and low-frame-rate displaying. However, in the case of frame rate switching or low-frame-rate displaying, a voltage of an initialization signal still needs to be adjusted for compensation, to avoid or alleviate flicker of the display.

For a display driver architecture of a small-sized display, a timing controller, a source driver, and the like are usually implemented in one chip, and communication between the timing controller and the source driver is convenient. Therefore, adjustment of an initialization signal in the small-sized display can be quite flexible.

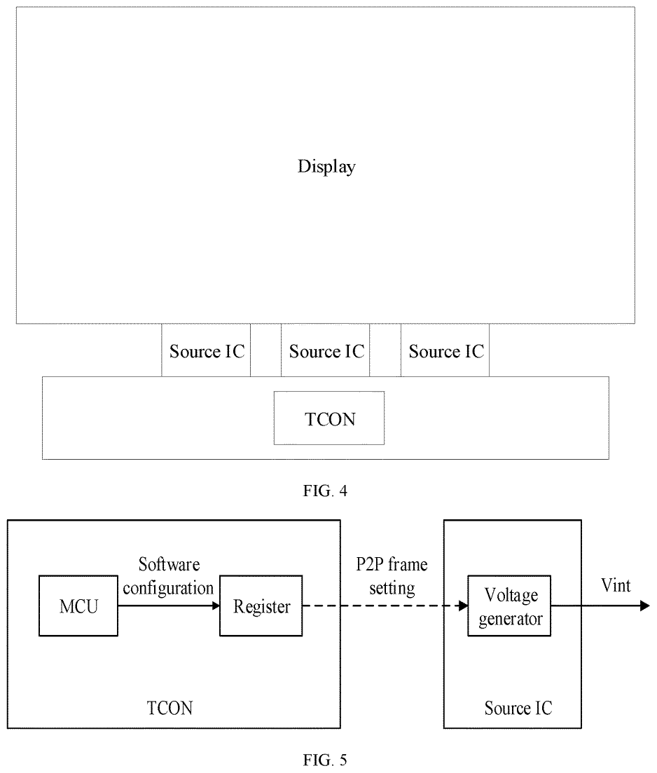

For a medium/large-sized display, as shown in FIG. 4, a timing controller (TCON), a source driver (Source IC), and the like of a DDIC are separated, and are not implemented in a same chip. This architecture is referred to as a TCON-source split architecture. In the TCON-source split architecture, an initialization signal is usually provided by the source driver for the display, and the timing controller and the source driver may transmit data and commands based on a point-to-point (P2P) protocol. For example, the timing controller sends a voltage value of an initialization signal needed by the display to the source driver, and the source driver provides the initialization signal for the display based on the voltage value. In this case, flexibility of voltage adjustment for the initialization signal cannot be ensured.

FIG. 5 is a diagram of a display driver. A voltage value of an initialization signal needed by a display may be calculated by using software that runs in a microcontroller unit (MCU) of a timing controller (TCON), and the calculated voltage value of the initialization signal is configured in a register. The voltage value of the initialization signal may be sent by a P2P transmission circuit to a source driver (Source IC) through a P2P setting instruction before each frame of display signal starts. For example, based on a response speed of the software, the P2P transmission circuit can send the voltage value of the initialization signal to the source driver through a P2P frame setting instruction. A voltage generator is disposed in the source driver, and the voltage generator may provide the initialization signal for the display based on the voltage value of the initialization signal.

However, due to limited hardware resources of the timing controller and a limited response speed of the software, in this adjustment and control mode, a voltage of the initialization signal can be adjusted only in a frame-wise manner, and row-level adjustment cannot be implemented, or timeliness cannot be ensured during row-level adjustment of the voltage of the initialization signal.

For example, if the initialization signal needs to be adjusted during displaying of a 20^{th} row and the initialization signal needs to be adjusted during displaying of a 30^{th} row, the software needs to identify content in the 20^{th} row and the 30th row of displayed content, insert an interrupt into each of the content in the 20^{th} row and the content in the 30^{th} row, and when identifying the interrupt, calculate a voltage value of the needed initialization signal, and send the calculated voltage value of the initialization signal to the source driver through a P2P command (for example, a P2P setting instruction). In this case, timeliness of adjustment cannot be ensured. For example, after the interrupt in the 20^{th} row is identified and the calculated voltage value of the initialization signal is sent to the source driver, the display may have displayed a 22^{nd} row or a 23^{rd} row, without meeting a requirement for timeliness of adjustment.

To resolve an existing problem that timeliness of adjustment of an initialization voltage cannot meet a requirement, embodiments of this application provide a display driver. An initialization signal is no longer adjusted based on software. Instead, a voltage value of an initialization signal needed by a display is determined based on logic hardware, the voltage value of the initialization signal needed by the display is directly embedded into a P2P setting instruction, and the P2P setting instruction is sent to a source driver, to adjust a voltage of the initialization signal. The following describes in detail the display driver provided in embodiments of this application with reference to the accompanying drawings.

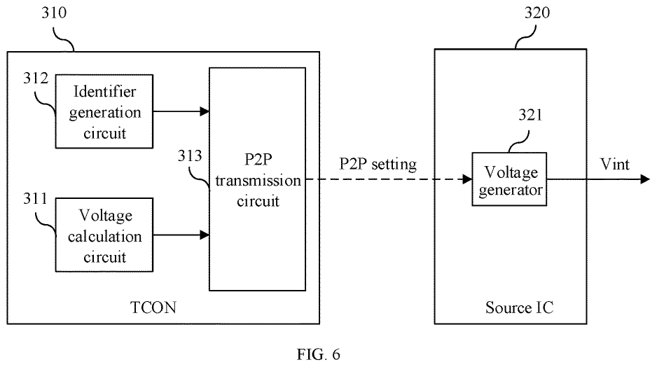

FIG. 6 is a diagram of a display driver according to an embodiment of this application. The display driver includes a timing controller 310 and a source driver 320. The timing controller 310 is communicatively connected to the source driver 320. The timing controller 310 includes a voltage calculation circuit 311, an identifier generation circuit 312, and a P2P transmission circuit 313.

The voltage calculation circuit 311 is configured to output, based on a specified algorithm, a voltage value of an initialization signal needed during displaying of an i^{th} row of pixel circuit of a display. The display includes a plurality of rows and a plurality of columns of pixel circuits. During displaying, the pixel circuits perform displaying in a row-wise manner from top to bottom. In different display stages, the pixel circuits need initialization signals with different voltages. The voltage calculation circuit 311 may determine a voltage value of an initialization signal needed by the display in a specific stage or during operation of a specific row of pixel circuit.

The identifier generation circuit 312 is configured to generate a switching identifier when the display switches to an i^{th} row of pixel circuit for displaying. The switching identifier indicates an occasion or a manner of switching a voltage value of an initialization signal. The switching identifier may be a logical action identifier, for example, a stop frame (frame skip), horizontal blanking (hblank), vertical blanking (vblank), a pixel count (hcount), a line count (vcount), horizontal active (hactive/de), or vertical active (vactive). For example, the identifier generation circuit 312 may generate a switching identifier upon switching to another row for displaying when displaying of one row is completed; or the identifier generation circuit 312 may count displayed pixels, and generate a switching identifier when the count reaches a quantity of pixels of one row. In some implementations, the identifier generation circuit 312 may be a pixel counter, a row counter, a frame counter, or the like.

The P2P transmission circuit 313 is configured to send a P2P setting instruction to the source driver 320, where the P2P setting instruction includes the voltage value of the initialization signal that is output by the voltage calculation circuit 311 and the switching identifier that is output by the identifier generation circuit 312. The P2P transmission circuit 313 may send the switching identifier and the voltage value of the initialization signal through the P2P setting instruction. For example, the P2P setting instruction herein may be a P2P line setting instruction. To be specific, before a signal is displayed in each row, the P2P line setting instruction including the switching identifier, the voltage value of the initialization signal, and the like is sent to the source driver 320.

The source driver 320 is configured to provide the initialization signal for the display based on the switching identifier and the voltage value of the initialization signal during displaying of the i^{th} row of pixel circuit of the display, where i is a positive integer. For example, during displaying of the i^{th} row of pixel circuit of the display, the initialization signal is provided for the display based on the voltage value, obtained by the voltage calculation circuit 311, of the initialization signal needed during displaying of the i^{th} row of pixel circuit.

In the display driver provided in this embodiment of this application, the timing controller includes the voltage calculation circuit and the identifier generation circuit. The voltage calculation circuit is configured to calculate a voltage value of an initialization signal needed during displaying of a row of pixel circuit of the display. The identifier generation circuit may generate a switching identifier for switching to a row for displaying. The voltage calculation circuit may send the calculated voltage value of the initialization signal to the P2P transmission circuit, without configuring a register by using software or obtaining a configured voltage value from a register, so that a response speed of voltage adjustment for the initialization signal can be increased. The identifier generation circuit may output the switching identifier. The P2P transmission circuit may send the voltage value of the initialization signal and the switching identifier to the source driver through a P2P setting instruction (for example, a P2P line setting instruction). During displaying of the row of pixel circuit, the source driver may provide the initialization signal for the display based on the switching identifier and the voltage value of the initialization signal that is output by the voltage calculation circuit. In comparison with an adjustment manner in which software of a timing controller is used to configure a register, no software of the timing controller needs to participate in adjustment, so that a response speed is higher. In addition, row-level response can be implemented, so that the initialization signal can be adjusted based on displaying of each row of pixel circuit, to improve display quality of dynamic-frame-rate displaying or low-frame-rate displaying.

The voltage calculation circuit may output, based on image data and screen temperature, the voltage value of the initialization signal needed by the display. To be specific, a voltage of the initialization signal output by the display driver may be dynamically adjusted based on the image data and the screen temperature, and a display condition and a frame rate may be obtained from the image data. The display condition may include, for example, any one of a grayscale histogram, a maximum grayscale pixel, an average grayscale, and display brightness (DBV). The voltage calculation circuit may output, based on the display condition, the screen temperature, and the frame rate, the voltage value of the initialization signal needed by the display.

The voltage calculation circuit may directly receive the image data, or may receive the image data through another circuit module and then transmit a processing result to the voltage calculation circuit.

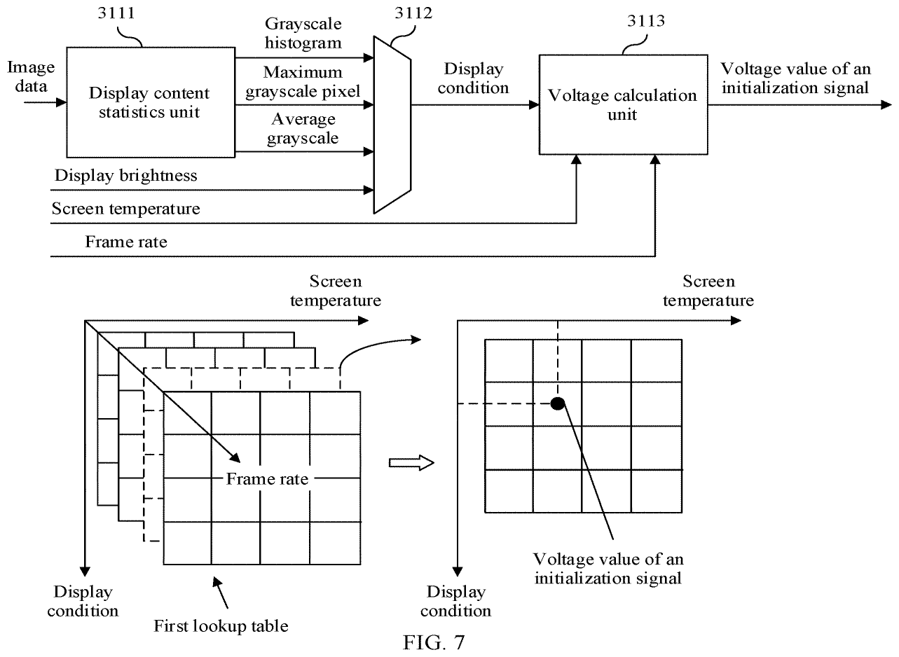

For example, in a possible implementation, as shown in FIG. 7, the voltage calculation circuit 311 includes a display content statistics unit 3111, a selection unit 3112, and a voltage calculation unit 3113. The display content statistics unit 3111 is configured to output the grayscale histogram, the maximum grayscale pixel, and the average grayscale based on the image data. The selection unit 3112 may select any one of the grayscale histogram, the maximum grayscale pixel, the average grayscale, and the display brightness as the display condition based on a specified selection mode, and output the display condition to the voltage calculation unit 3113. The voltage calculation unit 3113 is configured to determine, based on the display condition, the screen temperature, the frame rate, and a first lookup table, the voltage value of the initialization signal needed by the display, where the first lookup table stores a correspondence between the display condition, the screen temperature, the frame rate, and the voltage value of the initialization signal needed by the display.

For example, the first lookup table may be a three-dimensional lookup table that stores the correspondence between the display condition, the screen temperature, the frame rate, and the voltage value of the initialization signal needed by the display. For example, one dimension is the frame rate, one dimension is the screen temperature, and one dimension is the display condition. The voltage calculation unit 3113 may perform trilinear interpolation calculation to obtain the voltage value of the corresponding initialization signal. For example, the voltage calculation unit 3113 may first determine, through interpolation based on the frame rate, a two-dimensional lookup table of the display condition and the screen temperature; and then obtain, through bilinear interpolation calculation based on the display condition and the screen temperature, the voltage value of the initialization signal needed by the display.

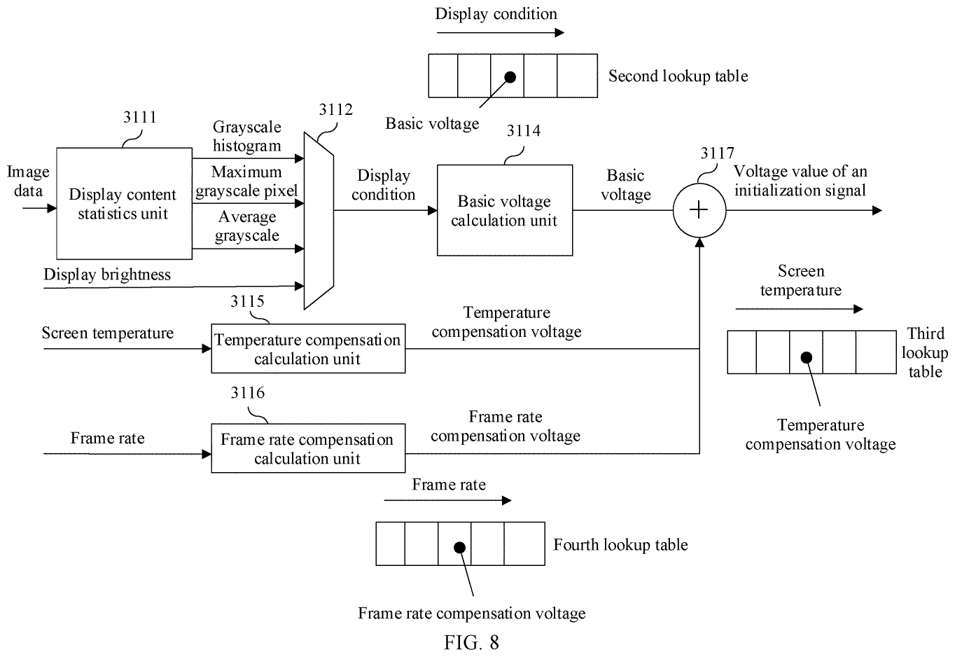

In another possible implementation, as shown in FIG. 8, the voltage calculation circuit 311 includes a display content statistics unit 3111, a selection unit 3112, a basic voltage calculation unit 3114, a temperature compensation calculation unit 3115, a frame rate compensation calculation unit 3116, and an addition circuit 3117. The display content statistics unit 3111 is configured to output the grayscale histogram, the maximum grayscale pixel, and the average grayscale based on the image data. The selection unit 3112 may select any one of the grayscale histogram, the maximum grayscale pixel, the average grayscale, and the display brightness as the display condition based on a specified selection mode, and output the display condition to the basic voltage calculation unit 3114.

The basic voltage calculation unit 3114 is configured to perform a linear interpolation operation based on the display condition and a second lookup table, and output a voltage value of a basic voltage, where the second lookup table stores a correspondence between the display condition and the voltage value of the basic voltage.

The temperature compensation calculation unit 3115 is configured to perform a linear interpolation operation based on the screen temperature and a third lookup table, and output a voltage value of a temperature compensation voltage, where the third lookup table stores a correspondence between the screen temperature and the voltage value of the temperature compensation voltage.

The frame rate compensation calculation unit 3116 is configured to perform a linear interpolation operation based on the frame rate and a fourth lookup table, and output a voltage value of a frame rate compensation voltage, where the fourth lookup table stores a correspondence between the frame rate and the voltage value of the frame rate compensation voltage.

The addition circuit 3117 is configured to output, based on the voltage value of the basic voltage, the voltage value of the temperature compensation voltage, and the voltage value of the frame rate compensation voltage, the voltage value of the initialization signal needed by the display. For example, the addition circuit 3117 sums up the voltage value of the basic voltage, the voltage value of the temperature compensation voltage, and the voltage value of the frame rate compensation voltage to obtain the voltage value of the initialization signal.

Still as shown in FIG. 6, the P2P transmission circuit 313 may send, to the source driver 320 through the P2P setting instruction, the voltage value of the initialization signal that is output by the voltage calculation circuit 311 and the switching identifier that is output by the identifier generation circuit 312.

The P2P setting instruction includes a P2P line setting instruction and a P2P frame setting instruction. An initialization signal that needs to be adjusted at a row level and a corresponding switching identifier may be sent to the source driver 320 through the P2P line setting instruction. An initialization signal that needs to be adjusted at a frame level and a corresponding switching identifier may be sent to the source driver 320 through the P2P frame setting instruction.

The source driver 320 includes a voltage generator 321, and the voltage generator 321 may generate the initialization signal based on the voltage value of the initialization signal. For example, if the voltage calculation circuit 311 determines that a voltage value of an initialization signal needed during displaying of a row of pixel circuit of the display is 3 V, the voltage generator 321 may generate a 3 V initialization signal, and provide the initialization signal for the display.

In the display driver provided in this embodiment of this application, a manner of adjusting an initialization signal through software may alternatively be retained. For example, the P2P transmission circuit may choose, based on a mode specified by a user, to send, to the source driver through a P2P setting instruction, the voltage value of the initialization signal that is output by the voltage calculation circuit or a voltage value of an initialization signal that is configured by software in a register. That is, the initialization signal may be adjusted through software configuration, or may be adjusted by logic hardware.

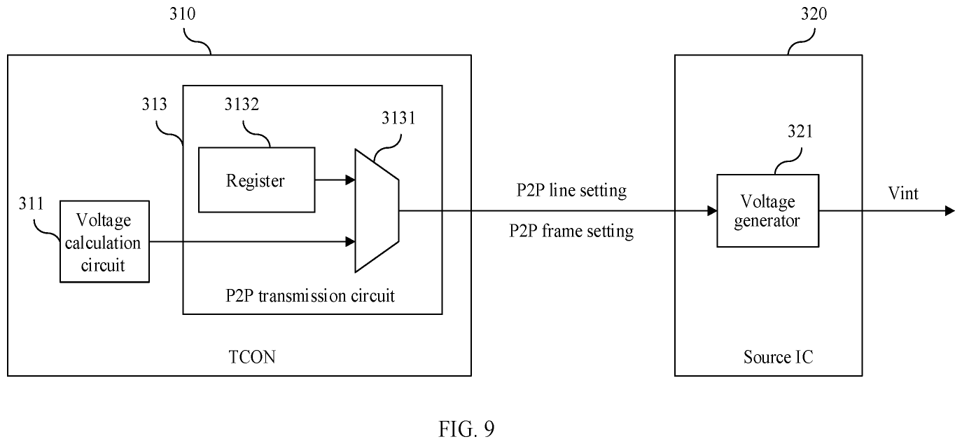

As shown in FIG. 9, in a possible implementation, the P2P transmission circuit 313 includes a selection unit 3131. The P2P transmission circuit 313 may choose, through the selection unit 3131 based on a mode configured by a user, to send, to the source driver 320 through P2P line setting, the voltage value of the initialization signal that is output by the voltage calculation circuit 311, so that the voltage of the initialization signal can be adjusted in a row-wise manner. Alternatively, the P2P transmission circuit 313 may send, to the source driver through a P2P line setting instruction via the selection unit 3131 based on a mode configured by a user, a voltage value of an initialization signal that is configured by software in a register 3132, so that the voltage of the initialization signal can be adjusted in a row-wise manner based on the voltage value of the initialization signal that is configured by the software. In this way, both a manner of dynamically adjusting a voltage of an initialization signal through logic hardware and a manner of adjusting a voltage of an initialization signal through software configuration can be retained.

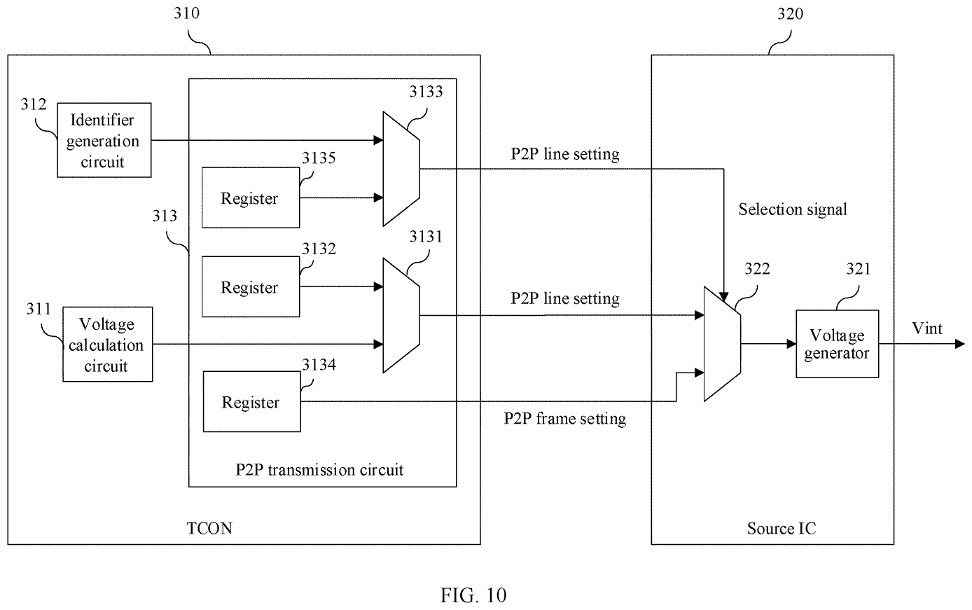

Alternatively, as shown in FIG. 10, the P2P transmission circuit 313 may send, to the source driver 320 through a P2P frame setting instruction, a voltage value of an initialization signal that is configured by software in a register 3132. The source driver 320 may be further provided with a fourth selection unit 322, and the fourth selection unit 322 may choose, based on a selection signal, to adjust the voltage of the initialization signal in a frame-wise manner or adjust the voltage of the initialization signal in a row-wise manner. For example, the fourth selection unit 322 may output, to the voltage generator 321, a voltage value of an initialization signal that is sent by the P2P transmission circuit 313 through a P2P line setting instruction, so that the voltage value of the initialization signal can be adjusted in the row-wise manner; or the fourth selection unit 322 may output, to the voltage generator 321, the voltage value of the initialization signal that is sent by the P2P transmission circuit 313 through the P2P frame setting instruction, so that the voltage value of the initialization signal can be adjusted in the frame-wise manner.

The selection signal may be a switching identifier output by the identifier generation circuit 312, for example, a logical action identifier like frame skip, vertical blanking, or horizontal blanking. Alternatively, the selection signal may be a selection signal configured by software in a register 3135. For example, the P2P transmission circuit 313 further includes a selection unit 3133. The P2P transmission circuit 313 may send, to the source driver 320 through a P2P setting instruction via the selection unit 3133, the switching identifier output by the identifier generation circuit 312 as a selection signal or the selection signal configured by the software in the register 3135. The fourth selection unit 322 in the source driver 320 may choose, based on the selection signal, to adjust the voltage of the initialization signal in a row-wise or frame-wise manner.

To ensure timeliness of switching, in this embodiment of this application, the P2P transmission circuit 313 may send, to the source driver 320 through P2P line setting, the selection signal output by the selection unit 3133. During specific implementation, the fourth selection unit 322 may choose, according to an actual requirement, to adjust the voltage of the initialization signal through frame-wise adjustment (frame setting) or row-wise adjustment (line setting), where the fourth selection unit 322 may perform selection based on the selection signal, and the selection signal may be the switching identifier, or may be the selection signal configured by the software.

The display has different requirements for adjustment ranges of different initialization signals. Some initialization signals only need to implement single-polarity voltage adjustment to meet a requirement. For example, the second initialization signal (Vint2) provided in the foregoing example needs to implement only negative voltage adjustment. Other initialization signals, for example, the first initialization signal (Vint1) and the third initialization signal (Vint3) in the foregoing example, need to implement positive voltage adjustment and negative voltage adjustment.

The source driver 320 may be provided with one or more voltage generators for each initialization signal. For an initialization signal that only needs to implement single-polarity voltage adjustment, one voltage generator may be disposed, to provide the single-polarity initialization signal. For example, in the examples shown in FIG. 6, FIG. 9, and FIG. 10, the source driver includes one voltage generator, for example, the voltage generator 321 shown in FIG. 6, FIG. 9, and FIG. 10. In this case, the voltage generator 321 may be electrically connected to a second initialization signal end of the display, and the voltage generator 321 may be configured to output the single-polarity (for example, negative-voltage) second initialization signal (Vint2). Correspondingly, the timing controller 310 includes one voltage calculation circuit, for example, the voltage calculation circuit 311 shown in FIG. 6, FIG. 9, and FIG. 10.

For an initialization signal that needs to implement positive and negative voltage adjustment, two voltage generators and a selection unit may be disposed. One voltage generator is configured to generate a positive-voltage initialization signal, and the other voltage generator is configured to generate a negative-voltage initialization signal. The selection unit selects the positive-voltage initialization signal or the negative-voltage initialization signal, and provides the initialization signal for the display. This can reduce a requirement for performance of the voltage generators, and reduce costs. In addition, if a single voltage generator switches between providing a positive voltage and providing a negative voltage, untimely response may occur. Therefore, the two voltage generators are disposed, where one is configured to generate the positive-voltage initialization signal, and the other is configured to generate the negative-voltage initialization signal; and the selection unit is configured to perform selection and switching, to increase a response speed for switching between a positive voltage and a negative voltage, and ensure flexibility of adjustment of the initialization signal.

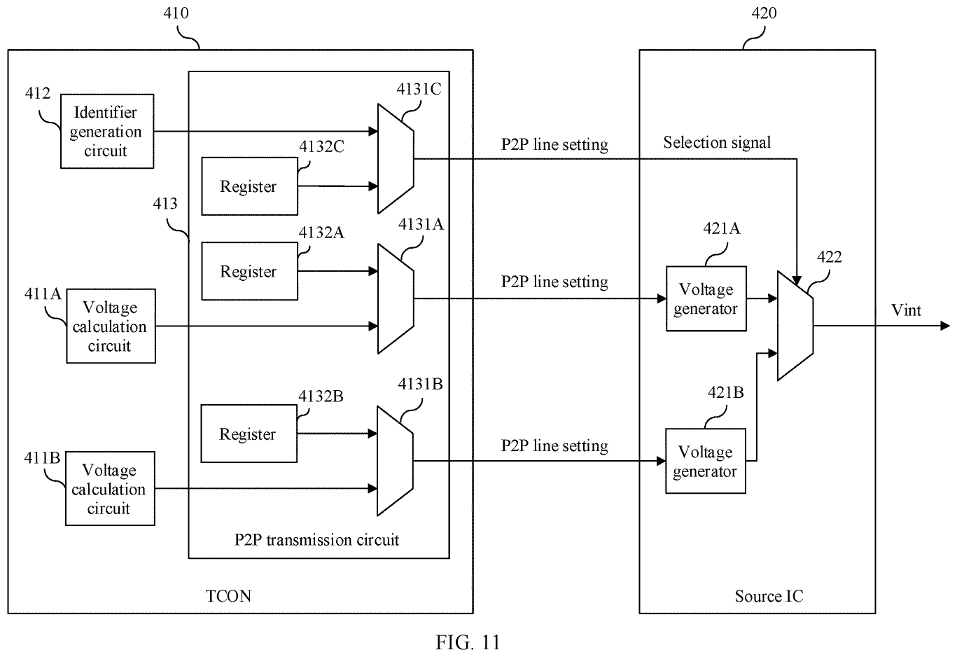

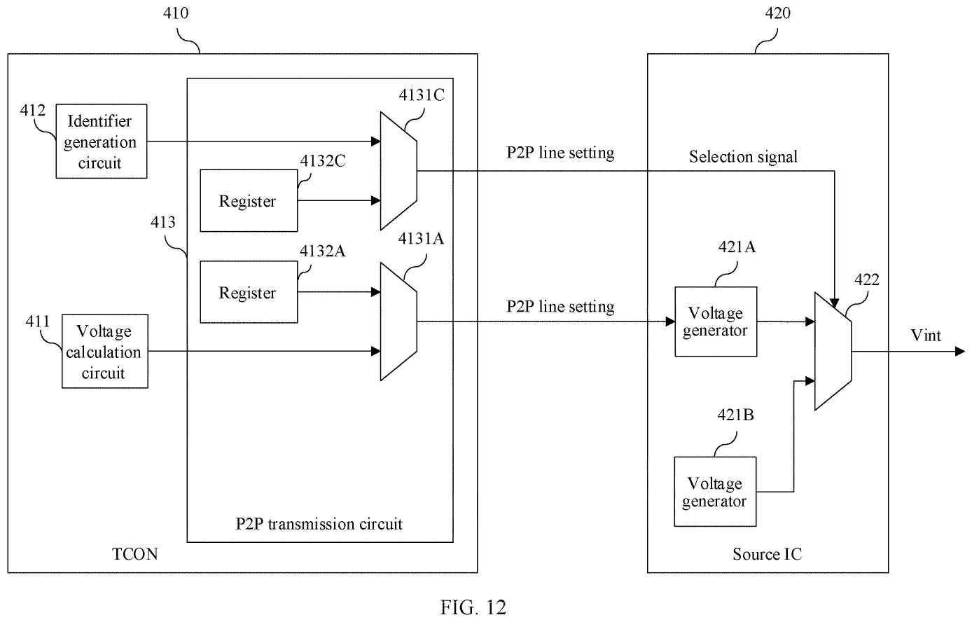

For example, refer to a display driver shown in FIG. 11. The source driver 420 includes two voltage generators, for example, a voltage generator 421A and a voltage generator 421B shown in the figure. The voltage generator 421A is configured to output a positive-voltage initialization signal, and the voltage generator 421B is configured to output a negative-voltage initialization signal.

The source driver 420 may further include a selection unit 422. The selection unit 422 may provide, for an initialization signal end of a display based on a selection signal, the positive-voltage initialization signal output by the voltage generator 421A or the negative-voltage initialization signal output by the voltage generator 421B.

Corresponding to the source driver 420, a timing control circuit 410 may also include two voltage calculation circuits, for example, a voltage calculation circuit 411A and a voltage calculation circuit 411B shown in FIG. 11. The voltage calculation circuit 411A may output a voltage value of the positive-voltage initialization signal, and the voltage calculation circuit 411B may output a voltage value of the negative-voltage initialization signal. A P2P transmission circuit 413 may send, to the source driver 420, the voltage value output by the voltage calculation circuit 411A and the voltage value output by the voltage calculation circuit 411B, so that the voltage generator 421A can generate the positive-voltage initialization signal based on the voltage value output by the voltage calculation circuit 411A, and the voltage generator 421B can generate the negative-voltage initialization signal based on the voltage value output by the voltage calculation circuit 411B.

A selection unit 422 of the source driver 420 may choose, based on a selection signal, to provide the positive-voltage initialization signal or the negative-voltage initialization signal for the display. The selection signal may be a switching identifier. For example, during row-level adjustment of the initialization signal, a first selection signal may be a switching identifier of row switching; and during frame-level adjustment of the initialization signal, a first selection signal may be a switching identifier of frame switching. This can implement quick switching between a positive voltage and a negative voltage.

The display driver provided in this embodiment of this application can improve switching of an initialization signal between a positive voltage and a negative voltage and response timeliness. Each initialization signal may be output after passing through a plurality of voltage generators and undergoing selection by the selection unit in the source driver, and the selection of the selection unit may be controlled by a switching identifier. For example, the switching identifier may be a logical action identifier like a stop frame (frame skip), horizontal blanking (hblank), vertical blanking (vblank), a pixel count (hcount), a row count (vcount), horizontal active (hactive/de), or vertical effective (vactive), to ensure timeliness and accuracy of switching.

A manner of configuring both the voltage value of the initialization signal and the selection signal by using software may be retained. For example, still as shown in FIG. 11, the P2P transmission circuit 413 further includes a selection unit 4131A, and the P2P transmission circuit 413 may choose, through the selection unit 4131A, to send, to the source driver 420 through a P2P setting instruction (for example, a P2P line setting instruction), the voltage value of the initialization signal that is output by the voltage calculation circuit 411A or a voltage value of an initialization signal that is configured by software in a register 4132A.

The P2P transmission circuit 413 further includes a selection unit 4131B, and the P2P transmission circuit 413 may choose, through the selection unit 4131B, to send, to the source driver 420 through a P2P setting instruction (for example, a P2P line setting instruction), the voltage value of the initialization signal that is output by the voltage calculation circuit 411B or a voltage value of an initialization signal that is configured by software in a register 4132B.

The P2P transmission circuit 413 further includes a selection unit 4131C, and the P2P transmission circuit 413 may send, to the source driver 420 through a P2P setting instruction (for example, a P2P line setting instruction) via the selection unit 4131C, a switching identifier output by an identifier generation circuit 412 as a selection signal or a selection signal configured by software in a register 4132C.

In some possible implementations, an initialization signal needs to switch between a positive voltage and a negative voltage. However, the positive voltage may need to be dynamically switched, and the negative voltage may be a fixed negative voltage and does not need to be adjusted. In this case, a voltage calculation circuit for outputting a voltage value of a negative-voltage initialization signal may not need to be disposed, and a voltage generator in a source driver may be configured to generate an initialization signal with the fixed negative voltage. To be specific, in this case, for the initialization signal, a timing controller may include only one voltage calculation circuit, configured to output a voltage value of a positive-voltage initialization signal; and the source driver includes two voltage generators, where one voltage generator is configured to generate the positive-voltage initialization signal based on the voltage value of the positive-voltage initialization signal, and the other voltage generator is configured to generate the initialization signal with the fixed negative voltage.

For example, FIG. 12 shows another display driver according to an embodiment of this application. A timing control circuit 410 includes a voltage calculation circuit 411. The voltage calculation circuit 411 may output a voltage value of a positive-voltage initialization signal. A P2P transmission circuit 413 may send, to a source driver 420 through a P2P setting instruction, the voltage value of the positive-voltage initialization signal that may be output by the voltage calculation circuit 411.

The source driver 420 includes two voltage generators, for example, a voltage generator 421A and a voltage generator 421B shown in the figure. The voltage generator 421A is configured to generate the positive-voltage initialization signal based on the voltage value output by the voltage calculation circuit 411, and the voltage generator 421B is configured to generate an initialization signal with a fixed negative voltage. In this embodiment of this application, no voltage calculation circuit needs to be configured to calculate a voltage value of a negative-voltage initialization signal, and the voltage generator 421B may generate the fixed negative voltage. This can reduce costs.

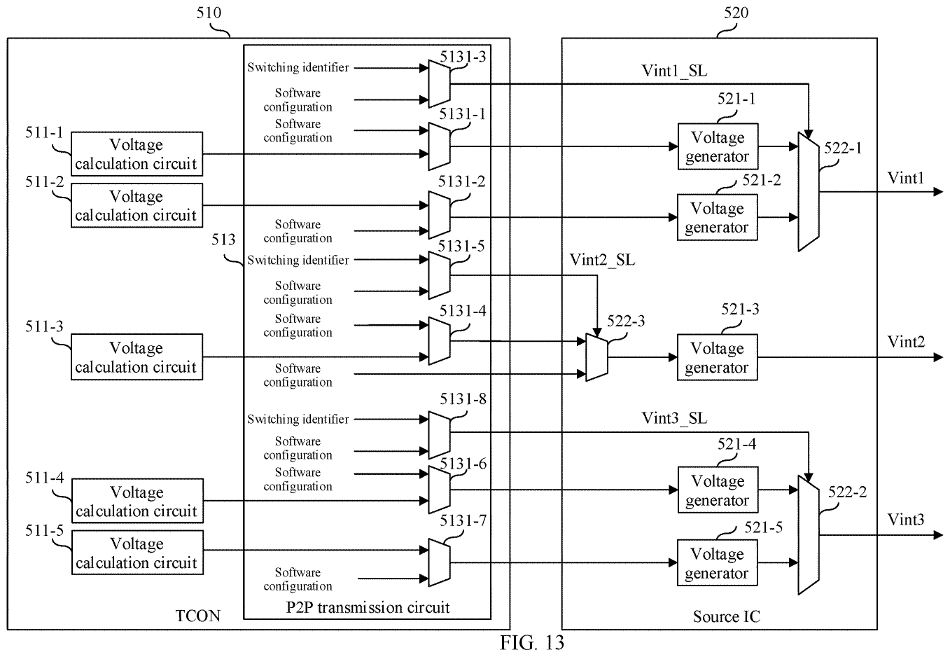

FIG. 13 shows another display driver according to an embodiment of this application. The display driver shown in FIG. 13 may simultaneously provide a plurality of initialization signals. For example, the display driver may provide a first initialization signal (VINT1), a second initialization signal (VINT2), and a third initialization signal (VINT3) for a display. The first initialization signal and the third initialization signal need to implement positive and negative voltage adjustment, and the second initialization signal needs to implement only negative voltage adjustment.

As shown in FIG. 13, the display driver includes a timing controller 510 and a source driver 520. The timing controller includes an identifier generation circuit (not shown in the figure), a plurality of voltage calculation circuits, and a P2P transmission circuit. The timing controller includes a plurality of voltage generators.

For example, the timing controller 510 includes a voltage calculation circuit 511-1, a voltage calculation circuit 511-2, a voltage calculation circuit 511-3, a voltage calculation circuit 511-4, and a voltage calculation circuit 511-5.

The voltage calculation circuit 511-1 is configured to output a voltage value of a positive-voltage first initialization signal based on image data and screen temperature. The voltage calculation circuit 511-2 is configured to output a voltage value of a negative-voltage first initialization signal based on the image data and the screen temperature. The voltage calculation circuit 511-3 is configured to output a voltage value of a second initialization signal based on the image data and the screen temperature. The voltage calculation circuit 511-4 is configured to output a voltage value of a positive-voltage third initialization signal based on the image data and the screen temperature. The voltage calculation circuit 511-5 is configured to output a voltage value of a negative-voltage third initialization signal based on the image data and the screen temperature.

A P2P transmission circuit 513 is configured to send, to the source driver 520 through a P2P setting instruction, the voltage values output by the plurality of voltage calculation circuits, a switching identifier, and the like. For example, if a requirement for adjustment flexibility of the first initialization signal, the second initialization signal, and the third initialization signal is high, the voltage values output by the plurality of voltage calculation circuits may be sent to the source driver 520 through a P2P line setting instruction. In some embodiments, for example, a requirement for adjustment flexibility of the first initialization signal is low, and a requirement for adjustment flexibility of the second initialization signal and the third initialization signal is high. In this case, the voltage values of the initialization signals that are output by the voltage calculation circuit 511-1 and the voltage calculation circuit 511-2 may be sent to the source driver 520 through a P2P frame setting instruction, one frame may be adjusted once or twice, and the voltage values of the initialization signals that are output by the voltage calculation circuit 511-3, the voltage calculation circuit 511-4, and the voltage calculation circuit 511-5 may be sent to the source driver 520 through a P2P line setting (line setting) instruction, to implement row-wise adjustment.

Corresponding to the plurality of voltage calculation circuits in the timing controller 510, the source driver 520 includes a plurality of voltage generators and a plurality of selection units. For example, the source driver 520 includes a voltage generator 521-1, a voltage generator 521-2, a voltage generator 521-3, a voltage generator 521-4, a voltage generator 521-5, a selection unit 522-1, a selection unit 522-2, and a selection unit 522-3.

The voltage generator 521-1 is configured to output the positive-voltage first initialization signal based on the voltage value of the positive-voltage first initialization signal that is output by the voltage calculation circuit 511-1. The voltage generator 521-2 is configured to output the negative-voltage first initialization signal based on the voltage value of the negative-voltage first initialization signal that is output by the voltage calculation circuit 511-2. The selection unit 522-1 is configured to choose, based on a first selection signal Vint1_SL, to output the positive-voltage or negative-voltage first initialization signal to a first initialization signal end of the display. For example, during displaying of an i^{th} row of pixel circuit, the display needs the positive-voltage first initialization signal; and during displaying of an (i+1)^{th} row of pixel circuit, the display needs the negative-voltage first initialization signal. The selection unit 522-1 may output, to the first initialization signal end of the display based on the first selection signal Vint1_SL during displaying of the i^{th} row of pixel circuit, the positive-voltage first initialization signal output by the voltage generator 521-1; and output, to the first initialization signal end of the display based on the first selection signal Vint1_SL during displaying of the (i+1)^{th} row of pixel circuit, the negative-voltage first initialization signal output by the voltage generator 521-2. The first selection signal Vint1_SL may be a switching identifier or a selection signal configured by software.

The voltage generator 521-3 is configured to generate the second initialization signal based on the voltage value of the second initialization signal that is output by the voltage calculation circuit 511-3, and provide the second initialization signal for a second initialization signal end of the display.

The voltage generator 521-4 is configured to output the positive-voltage third initialization signal based on the voltage value output by the voltage calculation circuit 511-4. The voltage generator 521-5 is configured to output the negative-voltage third initialization signal based on the voltage value output by the voltage calculation circuit 511-5. The selection unit 522-2 is configured to choose, based on a third selection signal Vint3_SL, to output the positive-voltage third initialization signal or the negative-voltage third initialization signal to a third initialization signal end of the display.

Each of the foregoing voltage generators may have at least two signal sources. For example, a selection unit 5131-1 may send, to the source driver 520 through a P2P line setting instruction, the voltage value of the initialization signal that is output by the voltage calculation circuit 511-1 or a voltage value of an initialization signal that is configured by software. A selection unit 5131-2 may send, to the source driver 520 through a P2P line setting instruction, the voltage value of the initialization signal that is output by the voltage calculation circuit 511-2 or a voltage value of an initialization signal that is configured by software. A selection unit 5131-3 may select a switching identifier as the first selection signal or a selection signal configured by software as the first selection signal, and send the first selection signal to the source driver 520 through a P2P line setting instruction.

A selection unit 5131-4 may send, to the source driver 520 through a P2P line setting instruction, the voltage value of the initialization signal that is output by the voltage calculation circuit 511-3 or a voltage value of an initialization signal that is configured by software. The selection unit 522-3 may select, as a signal source of the voltage generator 521-3 based on a second selection signal Vint2_SL, a voltage value of an initialization signal that is configured by software or a voltage value of an initialization signal that is selected by the selection unit 5131-4.

A selection unit 5131-6 may send, to the voltage generator 521-4 through a P2P line setting instruction, the voltage value of the initialization signal that is output by the voltage calculation circuit 511-4 or a voltage value of an initialization signal that is configured by software. A selection unit 5131-7 may send, to the voltage generator 521-5 through a P2P line setting instruction, the voltage value of the initialization signal that is output by the voltage calculation circuit 511-5 or a voltage value of an initialization signal that is configured by software. The selection unit 5131-6 may select a switching identifier as the third selection signal or a selection signal configured by software as the third selection signal, and send the third selection signal to the selection unit 522-2 through a P2P line setting instruction.

In this embodiment of this application, to ensure timeliness of switching, all of the first selection signal Vint1_SL, the second selection signal Vint2_SL, and the third selection signal Vint3_SL are transmitted through P2P line setting instructions.

In some embodiments, to reduce costs, an embodiment of this application further provides another display driver that may provide a plurality of initialization signals. For example, although a first initialization signal and a third initialization signal need to implement positive and negative voltage adjustment, only a positive voltage needs to be dynamically adjusted, and a negative-voltage initialization signal may have a fixed value and does not need to be dynamically adjusted. Therefore, in this case, a voltage generator may be reused for the first initialization signal and the third initialization signal that need to implement positive and negative voltage adjustment. Correspondingly, a quantity of voltage calculation circuits in a timing controller may be reduced.

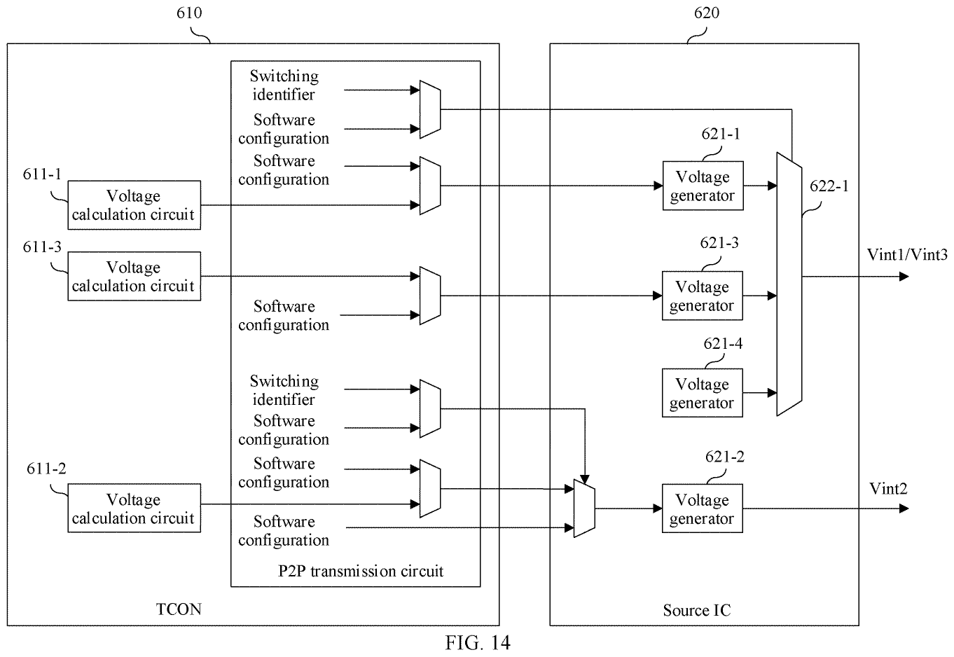

With reference to FIG. 14, a display driver shown in FIG. 14 includes a timing controller 610 and a source driver 620. The timing controller 610 includes a plurality of voltage calculation circuits and a P2P transmission circuit, and the timing controller includes a plurality of voltage generators.

For example, the timing controller 610 includes a voltage calculation circuit 611-1, a voltage calculation circuit 611-2, and a voltage calculation circuit 611-3.

The voltage calculation circuit 611-1 is configured to output a voltage value of a positive-voltage first initialization signal based on image data and screen temperature. The voltage calculation circuit 611-2 is configured to output a voltage value of a second initialization signal based on the image data and the screen temperature. The voltage calculation circuit 611-3 is configured to output a voltage value of a positive-voltage third initialization signal based on the image data and the screen temperature.

A P2P transmission circuit is configured to send, to the source driver through a P2P setting instruction, the voltage values output by the plurality of voltage calculation circuits, a switching identifier, and the like.

For example, the voltage values of the initialization signals that are output by the voltage calculation circuit 611-1, the voltage calculation circuit 611-2, and the voltage calculation circuit 611-3, the switching identifier, and the like may be sent to the source driver through a P2P line setting instruction, so that voltages of the initialization signals can be adjusted in a row-wise manner; or a voltage value of an initialization signal that is configured by software may be sent to the source driver 620 through a P2P line setting instruction or a P2P frame setting instruction, so that a voltage of the initialization signal can be adjusted based on a frame configured by the software.

The source driver 620 includes a plurality of voltage generators. For example, the source driver includes a voltage generator 621-1, a voltage generator 621-2, a voltage generator 621-3, and a voltage generator 621-4.

The voltage generator 621-1 is configured to generate the positive-voltage first initialization signal based on the voltage value output by the voltage calculation circuit 611-1. The voltage generator 621-2 is configured to generate the second initialization signal based on the voltage value output by the voltage calculation circuit 611-2. The voltage generator 621-3 is configured to generate the third initialization signal based on the voltage value output by the voltage calculation circuit 611-3. The voltage generator 621-4 is configured to output an initialization signal with a fixed negative voltage.

The source driver further includes a selection unit 622-1. The selection unit 622-1 may output the signal generated by the voltage generator 621-1 or the voltage generator 621-4 to a display as the first initialization signal, or output the signal generated by the voltage generator 621-3 or the voltage generator 621-4 to the display as the third initialization signal. Adjustment of the first initialization signal or the third initialization signal may be switched based on a switching identifier such as frame skip, vertical blanking, or horizontal blanking, or may be switched based on a selection signal configured by software.

The voltage generator 621-2 may provide the generated second initialization signal for the display, and the second initialization signal may be adjusted in a frame-wise row-wise manner.

In the display driver shown in FIG. 14, a voltage generator may be reused for the first initialization signal and the third initialization signal, and a quantity of voltage calculation circuits may be further reduced, so that costs are lower. The display driver may be configured to provide the second initialization signal and the first initialization signal for the display, or provide the second initialization signal and the third initialization signal for the display. If all of the first initialization signal, the second initialization signal, and the third initialization signal need to be provided, a plurality of source drivers may be disposed.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A display driver, wherein the display driver comprises a timing controller and a source driver, and the timing controller comprises a voltage calculation circuit, an identifier generation circuit, and a point-to-point (P2P) transmission circuit, and wherein:
the voltage calculation circuit is configured to determine a voltage value of an initialization signal needed during displaying of an i^{th} row of pixel circuit of a display, wherein i is a positive integer;
the identifier generation circuit is configured to generate a switching identifier when the display switches to the i^{th} row of pixel circuit for displaying, wherein the switching identifier indicates a switching occasion of the initialization signal;
the P2P transmission circuit is configured to send the switching identifier and the voltage value of the initialization signal to the source driver through a P2P setting instruction; and
the source driver is configured to provide the initialization signal for the display based on the switching identifier and the voltage value during displaying of the i^{th} row of pixel circuit of the display.

2. The display driver according to claim 1, wherein the voltage calculation circuit is configured to determine, based on a display condition, screen temperature, a frame rate, and a first lookup table, the voltage value of the initialization signal needed by the display, wherein the first lookup table stores a correspondence between the display condition, the screen temperature, the frame rate, and the voltage value of the initialization signal needed by the display, and wherein the display condition comprises any one of a grayscale histogram, a maximum grayscale pixel, an average grayscale, or screen brightness.

3. The display driver according to claim 1, wherein the voltage calculation circuit comprises a basic voltage calculation circuit, a temperature compensation calculation circuit, a frame rate compensation calculation circuit, and an addition circuit, and wherein:
the basic voltage calculation circuit is configured to determine a voltage value of a basic voltage based on a display condition and a second lookup table, wherein the second lookup table stores a correspondence between the display condition and the voltage value of the basic voltage, and the display condition comprises any one of a grayscale histogram, a maximum grayscale pixel, an average grayscale, and screen brightness;
the temperature compensation calculation circuit is configured to determine a voltage value of a temperature compensation voltage based on screen temperature and a third lookup table, wherein the third lookup table stores a correspondence between the temperature and the voltage value of the temperature compensation voltage;
the frame rate compensation calculation circuit is configured to determine a frame rate compensation voltage based on a frame rate and a fourth lookup table, wherein the fourth lookup table stores a correspondence between the frame rate and a voltage value of the frame rate compensation voltage; and
the addition circuit is configured to sum up the voltage value of the basic voltage, the voltage value of the temperature compensation voltage, and the voltage value of the frame rate compensation, and output the voltage value of the initialization signal needed by the display.

4. The display driver according to claim 1, wherein the source driver comprises a voltage generator, and the voltage generator is configured to output, based on the voltage value sent by the P2P transmission circuit, the initialization signal during displaying of the i^{th} row of pixel circuit of the display.

5. The display driver according to claim 4, wherein:
the timing controller comprises a first voltage calculation circuit and a second voltage calculation circuit,
the first voltage calculation circuit is configured to determine a voltage value of a positive-voltage initialization signal needed during displaying of the i^{th} row of pixel circuit of the display;
the second voltage calculation circuit is configured to determine a voltage value of a negative-voltage initialization signal needed during displaying of the i^{th} row of pixel circuit of the display;
the source driver comprises a first selection circuit, a first voltage generator, and a second voltage generator, wherein;
the first voltage generator is configured to output the positive-voltage initialization signal based on the voltage value of the positive-voltage initialization signal;
the second voltage generator is configured to output the negative-voltage initialization signal based on the voltage value of the negative-voltage initialization signal; and
the first selection circuit is configured to choose, based on a selection signal, to output the positive-voltage or negative-voltage initialization signal during displaying of the i^{th} row of pixel circuit of the display.

6. The display driver according to claim 4, wherein:
the source driver comprises a second selection circuit and a voltage generator;
the second selection circuit is configured to choose, based on a selection signal, to output, to the voltage generator, a first voltage value sent by the P2P transmission circuit through a P2P line setting instruction or a second voltage value sent by the P2P transmission circuit through a P2P frame setting instruction; and
the voltage generator is configured to output the initialization signal based on the first voltage value or the second voltage value that is output by the second selection circuit.

7. The display driver according to claim 5, wherein the selection signal is a switching identifier sent by the P2P transmission circuit through a P2P line setting instruction.

8. The display driver according to claim 4, wherein the P2P transmission circuit comprises a register and a third selection circuit, and the register is configured to store a voltage value of an initialization signal that is configured by software; and
wherein the P2P transmission circuit is further configured to send, to the source driver through the third selection circuit, the voltage value in the register or the voltage value output by the voltage calculation circuit.

9. The display driver according to claim 7, wherein the P2P transmission circuit comprises a register and a fourth selection circuit, and the register is configured to store a selection signal configured by software; and
wherein the P2P transmission circuit is further configured to choose, through the fourth selection circuit, to use the switching identifier as a selection signal or send the selection signal in the register to the source driver through a P2P line setting instruction.

10. A display module, wherein the display module comprises a display and a display driver, and the display driver is configured to output an initialization signal to the display, wherein the display driver comprises a timing controller and a source driver, and the timing controller comprises a voltage calculation circuit, an identifier generation circuit, and a point-to-point (P2P) transmission circuit, and wherein:
the voltage calculation circuit is configured to determine a voltage value of an initialization signal needed during displaying of an i^{th} row of pixel circuit of a display, wherein i is a positive integer;
the identifier generation circuit is configured to generate a switching identifier when the display switches to the i^{th} row of pixel circuit for displaying, wherein the switching identifier indicates a switching occasion of the initialization signal;
the P2P transmission circuit is configured to send the switching identifier and the voltage value of the initialization signal to the source driver through a P2P setting instruction; and
the source driver is configured to provide the initialization signal for the display based on the switching identifier and the voltage value during displaying of the i^{th} row of pixel circuit of the display.

11. The display module according to claim 10, wherein the voltage calculation circuit is configured to determine, based on a display condition, screen temperature, a frame rate, and a first lookup table, the voltage value of the initialization signal needed by the display, wherein the first lookup table stores a correspondence between the display condition, the screen temperature, the frame rate, and the voltage value of the initialization signal needed by the display, and wherein the display condition comprises any one of a grayscale histogram, a maximum grayscale pixel, an average grayscale, or screen brightness.

12. The display module according to claim 10, wherein:
the voltage calculation circuit comprises a basic voltage calculation circuit, a temperature compensation calculation circuit, a frame rate compensation calculation circuit, and an addition circuit;
the basic voltage calculation circuit is configured to determine a voltage value of a basic voltage based on a display condition and a second lookup table, wherein the second lookup table stores a correspondence between the display condition and the voltage value of the basic voltage, and the display condition comprises any one of a grayscale histogram, a maximum grayscale pixel, an average grayscale, and screen brightness;
the temperature compensation calculation circuit is configured to determine a voltage value of a temperature compensation voltage based on screen temperature and a third lookup table, wherein the third lookup table stores a correspondence between the temperature and the voltage value of the temperature compensation voltage;
the frame rate compensation calculation circuit is configured to determine a frame rate compensation voltage based on a frame rate and a fourth lookup table, wherein the fourth lookup table stores a correspondence between the frame rate and a voltage value of the frame rate compensation voltage; and
the addition circuit is configured to sum up the voltage value of the basic voltage, the voltage value of the temperature compensation voltage, and the voltage value of the frame rate compensation, and output the voltage value of the initialization signal needed by the display.

13. The display module according to claim 10, wherein the source driver comprises a voltage generator, and the voltage generator is configured to output, based on the voltage value sent by the P2P transmission circuit, the initialization signal during displaying of the i^{th} row of pixel circuit of the display.

14. The display module according to claim 13, wherein:
the timing controller comprises a first voltage calculation circuit and a second voltage calculation circuit;
the first voltage calculation circuit is configured to determine a voltage value of a positive-voltage initialization signal needed during displaying of the i^{th} row of pixel circuit of the display;
the second voltage calculation circuit is configured to determine a voltage value of a negative-voltage initialization signal needed during displaying of the i^{th} row of pixel circuit of the display;
the source driver comprises a first selection circuit, a first voltage generator, and a second voltage generator,
the first voltage generator is configured to output the positive-voltage initialization signal based on the voltage value of the positive-voltage initialization signal;
the second voltage generator is configured to output the negative-voltage initialization signal based on the voltage value of the negative-voltage initialization signal; and
the first selection circuit is configured to choose, based on a selection signal, to output the positive-voltage or negative-voltage initialization signal during displaying of the in row of pixel circuit of the display.

15. The display module according to claim 13, wherein:
the source driver comprises a second selection circuit and a voltage generator;
the second selection circuit is configured to choose, based on a selection signal, to output, to the voltage generator, a first voltage value sent by the P2P transmission circuit through a P2P line setting instruction or a second voltage value sent by the P2P transmission circuit through a P2P frame setting instruction; and
the voltage generator is configured to output the initialization signal based on the first voltage value or the second voltage value that is output by the second selection circuit.

16. The display module according to claim 14, wherein the selection signal is a switching identifier sent by the P2P transmission circuit through a P2P line setting instruction.

17. The display module according to claim 13, wherein the P2P transmission circuit comprises a register and a third selection circuit, and the register stores a voltage value of an initialization signal that is configured by software; and
wherein the P2P transmission circuit is further configured to send, to the source driver through the third selection circuit, the voltage value in the register or the voltage value output by the voltage calculation circuit.

18. The display module according to claim 16, wherein the P2P transmission circuit comprises a register and a fourth selection circuit, and the register stores a selection signal configured by software; and
wherein the P2P transmission circuit is further configured to choose, through the fourth selection circuit, to use the switching identifier as a selection signal or send the selection signal in the register to the source driver through a P2P line setting instruction.

19. An electronic device, comprising a housing and a display module, wherein the display module is installed on the housing, wherein display module comprises a display and a display driver, and the display driver is configured to output an initialization signal to the display, wherein the display driver comprises a timing controller and a source driver, and the timing controller comprises a voltage calculation circuit, an identifier generation circuit, and a point-to-point (P2P) transmission circuit, and wherein:
the voltage calculation circuit is configured to determine a voltage value of an initialization signal needed during displaying of an i^{th} row of pixel circuit of a display, wherein i is a positive integer;
the identifier generation circuit is configured to generate a switching identifier when the display switches to the i^{th} row of pixel circuit for displaying, wherein the switching identifier indicates a switching occasion of the initialization signal;
the P2P transmission circuit is configured to send the switching identifier and the voltage value of the initialization signal to the source driver through a P2P setting instruction; and
the source driver is configured to provide the initialization signal for the display based on the switching identifier and the voltage value during displaying of the i^{th} row of pixel circuit of the display.

20. The electronic device according to claim 19, wherein the voltage calculation circuit is configured to determine, based on a display condition, screen temperature, a frame rate, and a first lookup table, the voltage value of the initialization signal needed by the display, wherein the first lookup table stores a correspondence between the display condition, the screen temperature, the frame rate, and the voltage value of the initialization signal needed by the display, and wherein the display condition comprises any one of a grayscale histogram, a maximum grayscale pixel, an average grayscale, or screen brightness.
